(19) United States
(12) Patent Application Publication
(10) Pub. No.: US 2008/0244544 A1
(43) Pub. Date: Oct. 2, 2008

(54) Using hardware checkpoints to support software based speculation

(76) Inventors: Naveen Neelakantam, Urbana, IL (US); Craig Zilles, Champaign, IL (US); Uma Srinivasan, Sunnyvale, CA (US); Suresh Srinivas, Portland, OR (US); Ravi Rajwar, Portland, OR (US); Konrad Lai, Vancouver, WA (US)

Correspondence Address: TROP PRUNER & HU, PC, 1616 S. VOSS ROAD, SUITE 750, HOUSTON, TX, 77057-2631, US

(21) Appl. No.: 11/729,724

(22) Filed: Mar. 29, 2007

(51) Int. Cl. G06F 9/45

(52) U.S. Cl. 717/147

(57) ABSTRACT

Hardware checkpoints may be used to mark software-based speculation regions. An instruction may be provided at the beginning of a speculation region and at the end of the speculation region. If an exception occurs during the speculation region, a hardware rollback may be occurred. The hardware rollback rolls back to the instruction at the beginning of the speculation region. The hardware may take a checkpoint by taking a register snapshot and treating future memory updates as tentative. When the instruction marking the end of the speculation is reached, all the tentative memory updates are committed and the previously taken register snapshot is discarded.

### BACKGROUND

This relates to the execution of software programs. More specifically, an embodiment relates to a method and system for supporting software based speculation.

The need for increased portability of software programs has resulted in increased development and usage of runtime environments. The term “portability” refers to the ability to execute a given software program on a variety of computer platforms having different hardware, operating systems, etc. The term “runtime environment” may also be referred to as the runtime system or virtual machine. The runtime environment allows software programs and source code format to be executed by a target execution platform (i.e. the hardware and operating system of a computer system) in a platform-independent manner. This means that source code instructions are not statically compiled and linked directly into native or machine code for execution by the target execution platform. Instead, the instructions are statically compiled into an intermediate language (e.g., byte-code) and the intermediate language may then be interpreted or subsequently compiled by a just-in-time compiler within the runtime environment into native or machine code that can be executed by the target execution platform.

### BRIEF DESCRIPTION OF THE DRAWINGS

FIG. 1 is a block diagram showing an exemplary architecture that compiles and executes a software program in source code format, wherein the architecture includes a virtual machine (or runtime environment) within which one embodiment of the present invention may be implemented; and

FIG. 2 is a flow chart for one embodiment of the present invention.

### DETAILED DESCRIPTION

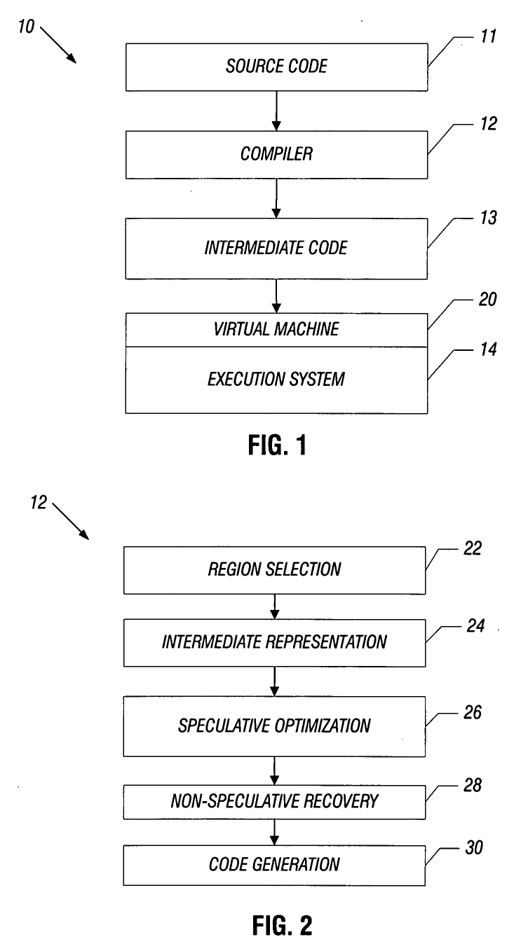

Referring to FIG. 1, the software program compilation execution system 10 includes a compiler 12 that compiles a source code program into an intermediate language code 13. The source code 11 may be written in any one of the object oriented programming languages.

In one embodiment, the object oriented programming language is Java (developed by Sun Microsystems, Inc.) and, in other embodiments, the language is a programming language that conforms to the common language infrastructure developed by Microsoft Corporation of Redman, Wash., for its NET technology, now standardized by the International Organization for Standardization as Standard ISO/IEC 23271.

The compiler 12 compiles the source code program 11 to generate the intermediate language code 13. The compiler 12 may be a software system run on a computer system.

The intermediate language code 13 is stored in a memory of the computer system. When the source code program 11 is written in Java, the intermediate language code is Java byte code. If, however, the source code 11 is written in a programming language conforming to the common language infrastructure, then the intermediate code is in common intermediate language code.

The system 10 also includes a virtual machine and an execution system that further compiles the intermediate language code into native code and executes the native code. According to one embodiment, the native code is machine code that is particular to a specific architecture or platform. The execution system 14 employs a virtual machine 20 to compile the intermediate language code 13 into native code that is platform specific or architecture specific to the execution system 14 and executes the native code. The virtual machine 20 can also be referred to as the runtime environment or runtime system. The virtual machine 20 is hosted by execution system 14.

The execution system 14 can be, for example, a personal computer, a personal digital assistant, a network computer, a server computer, a notebook computer, a work station, a mainframe computer, or a super computer. Alternatively, the execution system 14 can be one of any of a number of electronic systems with data processing capabilities. The intermediate language code 13 may be delivered to the execution system 14 by a communication link such as a local area network, the Internet, or a wireless communication network. The execution system 14 includes an operating system and system specific hardware. The operating system can be an open standard Linux operating system or other type of operating system. The system specific hardware of the execution system 14 can be any hardware that includes all necessary modules to execute the operating system.

In one embodiment, the virtual machine is implemented as a software system. In this case, the virtual machine 20 runs on the execution system 14. The virtual machine may also be a Java virtual machine. In another embodiment, the virtual machine 20 can be any type of runtime system or may be implemented by other techniques such as firmware systems.

In accordance with one embodiment, a mechanism for improving a sequential and parallel performance of applications running within managed runtime environments may be provided. The mechanism uses hardware check points to support speculative optimizations with the ahead-of-time or just-in-time compiler frameworks. Hardware checkpoints enable trivial misspeculation recovery, removing a source of complexity hindering the implementation of speculative compiler optimizations. The compiler 12 uses profile directed feedback or static heuristics to identify repetitive application behaviors and exploits them with aggressive speculative optimization (software speculation).

The exposure of the instruction set support for checkpointing and rollback can make dynamic optimization and managed runtime both simpler and more powerful. With an efficient rollback mechanism, managed runtimes can generate code that assumes that uncommon program behaviors, such as errors, exceptions, and biased branches changing their bias, will not occur, simplifying control flow and thereby removing constraints on optimization. If one of these uncommon behaviors occurs, the execution can be rolled back and an alternate version of the code may be used. In this way, a software exposed hardware checkpoint feature provides a general mechanism for managing aggressive software speculation.

High performance ahead-of-time or just-in-time compilers already provide the framework necessary to identify and speculatively optimize repetitive application behaviors. These compilers either profile the application using software instrumentation or hardware based sampling or use static heuristics to identify common application behaviors in hot methods. Once identified, the compiler optimizes hot methods using the collected profiles or static heuristics to guide aggressive software speculation. A hot method is a method which occurs many times within the code. An advantage provided by the compiler is the availability of high level information, such as source or byte code, to enable optimizations with high level scope such as speculative inlining of virtual methods, bounds check elimination, and elimination of try/catch blocks for applications written in Java.

Normally, a just-in-time compiler has difficulty to speculatively optimize for a hot path. This is because if one of the unexpected paths were executed, the compiler would have to guarantee that any of the speculative updates to memory or registers could be undone. Exception conditions make the situation more complicated, because the compiler must guarantee that any potentially exception causing memory accesses are not performed until the control flow leading up to the access is known and is, therefore, not speculative.

In some embodiments, the just-in-time compiler 12 speculates that a hot path is the only path taken through a method. The compiler also wraps the speculative code with a begin_spec/end_spec instruction pair. The begin_spec instruction indicates the start of a speculative region and instructs the hardware to take a checkpoint. The hardware takes a checkpoint by taking a register snapshot and treating all future memory updates as tentative. The end_spec instruction terminates the speculative region and allows the hardware to atomically commit all tentative memory updates and discard the previously taken register snapshot.

The just-in-time compiler 12 also inserts assert instructions for each speculation made in the region. The assert on each condition guarantees the expected path is executed. If an assert instruction fires, the hardware rolls execution back to the checkpoint taken at the begin_spec instruction and also redirects execution to a handler that can invoke a non-speculative version of the method. In this way, if an unexpected path is executed, any state speculatively modified is thrown away and a version of the method is invoked that implements all potential paths.

Some speculation conditions may not require assert instructions. For example, the compiler 12 may speculate that exception conditions do not occur. The hardware can be designed so that exceptions implicitly indicate a misspeculation. If an exception occurs while in a speculative region, the hardware rolls execution back to the most recently taken checkpoint and redirects to a handler. As with an explicit assert, the handler can then invoke a non-speculative version of the method.

The execution system 14 treats tentative memory accesses, such as reads and writes, differently than normal memory accesses. The first time a memory location is tentatively read, the execution system 14 buffers the read value and all future tentative reads to the same location receive the buffered value. Each time a memory location is tentatively written, its most recent value is buffered. In addition, tentative memory writes do not modify the values contained in main memory. Both tentative reads and writes do not cause changes to the coherence states of lines contained in other processors with the execution system 14.

The spec_begin instruction takes a register snapshot and records the address of the spec_begin instruction into a status register. The address is captured for use by a software abort handler. All future memory accesses are tentative. All tentative memory accesses are buffered until committed or discarded.

The spec_end instuction atomically commits all tentative memory accesses. This commit involves first verifying that the values tentatively read match the values currently stored in main memory and then exclusively updating main memory with the buffered values of all tentative writes. If the commit process succeeds, then the previously taken register checkpoint is discarded and future memory accesses are non-tentative. If the commit fails, all tentative memory accesses are discarded, the register snapshot is restored, and control transfers to a software handler pursuant to a sequence of steps called an abort.

The assert instruction verifies that an expected condition holds. If the condition holds, the assert is a no operation. If the condition does not hold the address of the abort instruction is captured into a status register and an abort occurs as described above. Note that the assert can also be implemented as a predicated abort instruction or as a compare-and-branch sequence with an unconditional assert as a taken target.

In a speculative region, all exceptions implicitly cause an abort. The cause of the exception is captured into a status register for inspection by the software abort handler. If the exception is synchronous, then the address of the instruction causing the exception is also captured into a status register.

The operation of the compiler 12 is shown in FIG. 2. Initially, in block 22, the compiler framework provides the means for identifying hot methods and loops and identifying the hot paths through them, indicated as region selection (block 22). Instrumentation-based profiling or event-based sampling can both accurately guide region selection. Static heuristics can alternatively be used, but may be less accurate than the feedback-directed techniques.

Then, an intermediate representation 24 is developed. Intermediate code 13 is different than compiler intermediate representation 24. Intermediate code is a binary encoding of an application, but is different from native code because it is machine-independent (and, therefore, must either be interpreted or compiled before being executed) and typically contains some high-level metadata (which enables traditional compiler optimizations). The compiler intermediate representation, on the other hand, is a set of in-memory data structures and their contents that is used by the compiler to represent a program being compiled. It is created by the compiler at the start of compilation, and the compiler performs optimizations by applying various transformations to the intermediate representation before (or sometimes in the process of) converting it to native code.

The spec_begin/spec_end instructions are used to mark the entry and exit points of a speculative region. In the compiler intermediate representation, the spec_begin instruction is a potentially exception causing instruction. If an abort occurs, the program rolls back to the state immediately prior to the execution of the spec_begin instruction and redirects to an abort handler. The spec_assert instruction is used to represent speculative assumptions made by the compiler. Although in practice the spec_assert instruction can cause a control transfer, the compiler can optimize it like a standard dataflow operation, for example, by removing redundant asserts. Therefore, the meaning of the spec_assert operation in the compiler intermediate representation 24 is purely dataflow and has no control.

Using profile information or static heuristics, speculative optimizations 26 convert biased application behaviors into spec_assert operations. For example, these optimizations convert regions containing biased branches into speculative regions containing spec_assert operations which verify the expected branch outcome. These optimizations improve the effectiveness of other compiler passes by increasing the effective size of basic blocks and reducing control-flow graph complexity.

If a misspeculation occurs, the hardware rolls execution back to the state immediately preceding execution of the spec_begin operation as part of non-speculative recovery 28. It also redirects to a software abort handler. This handler inspects hardware status registers to determine the cause of the abort and the affected speculative region. The handler finds a non-speculative method corresponding to the speculative region, invoking the compiler to generate it if necessary, and restarts the application at the appropriate point in the non-speculative method.

The spec_begin and spec_end operations are converted to native instructions which take and commit a checkpoint respectively in the code generation 30. On a system 14 with hardware transactional memory, the begin_trans and end_trans instructions suffice. The spec_assert operation is converted to native instructions which conditionally trigger an abort if the speculation condition does not hold. This may be implemented with a compare-and-branch sequence with an unconditional abort as the taken point. On a system with hardware transactional memory, the unconditional abort may be implemented with an abort_trans instruction or the equivalent. The net effect is to generate the needed native code.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A computer readable medium storing instructions to enable a computer to:
implement software speculation using hardware based checkpoints to mark a selected speculation region; and
institute hardware rollback in the case an exception occurs in the speculation region.

2. The medium of claim 1 storing instructions to enable a compiler to speculate that a hot path is the only path taken through a method.

3. The medium of claim 2 storing instructions to insert an instruction at the start of a speculation region and at the end of a speculation region.

4. The medium of claim 3 storing instructions to implement a checkpoint by taking a register snapshot and treat future memory updates as tentative.

5. The medium of claim 4 storing instructions to provide an instruction at the end of the speculation region to commit all tentative memory updates and discard the previously taken register snapshot.

6. The medium of claim 5 storing instructions to provide a rollback to the instruction marking the beginning of the speculation region.

7. A system comprising:
a computer-based execution system; and
a runtime system stored in and run on the execution system that includes a compiler to implement software speculation using hardware based checkpoints to mark a selected speculation region and to institute hardware rollback in case an exception occurs in a speculation region.

8. The system of claim 7, said compiler to speculate that a hot path is the only path taken through a method.

9. The system of claim 8, said compiler to insert an instruction at the start of a speculation region and at the end of a speculation region.

10. The system of claim 9, said compiler to implement a checkpoint by taking a register snapshot and treating future memory updates as tentative.

11. The system of claim 10, said compiler to provide an instruction at the end of the speculation region to commit all memory updates and discard the previously taken snapshot register.

12. The system of claim 11, said compiler to rollback to the instruction marking the beginning of the speculation region.
